(19) United States
(12) Patent Application Publication
(10) Pub. No.: US 2008/0049987 A1
(43) Pub. Date: Feb. 28, 2008

(54) Fingerprint recognition system

(76) Inventors: Katrina S. Champagne, Palmer, MA (US); Joseph J. Turek, Palmer, MA (US); Robert J. Encamacion, Van Nuys, CA (US)

Correspondence Address: Ashok Tankha, Esq.;Lipton, Weinberger & Husick, 36 Greenleigh Drive, Sewell, NJ, 08080, US

(21) Appl. No.: 11/511,146

(22) Filed: Aug. 28, 2006

(51) Int. Cl. G06K 9/00

(52) U.S. Cl. 382/124

(57) ABSTRACT

A method and system of increasing the acceptance rate in fingerprint scans by the application of cascaded selective, plural and sequenced fingerprint recognition rules using a plurality of sensors. The finger is swiped over multiple sensors. A whole fingerprint sample is constructed from the scan of each of the multiple sensors, thereby generating a multiplicity of whole fingerprint samples. Predetermined selective, plural and sequenced fingerprint recognition rules are set for each of the whole fingerprint samples. The sequence of application of the rules is set for the fingerprint recognition. The accuracy level for fingerprint recognition is set. The selective, plural and sequenced fingerprint recognition rules are sequentially applied to match the captured fingerprint image with stored fingerprint templates. The stored fingerprint templates are sequentially filtered until the set accuracy level is achieved.

### BACKGROUND

This invention in general relates to a method and system of biometric authentication, and in particular to a technique of increasing the acceptance rate in the capture and authentication of fingerprints.

Given the increasing use of fingerprint recognition systems, there is a market need to significantly improve the accuracy and reliability of the system, taking advantage of the increasing processing speed and capacity of existing embedded software and hardware computing solutions. There is a need to replace authentication methods that require PIN, passwords or tokens, etc., which are comparatively less reliable and often suffer from spoof or stolen or internal fraud.

The existing fingerprint authentication systems do not provide a wide range of options to the administrator to set a plurality of security levels or fingerprint image capturing and quality levels. In existing solutions, there is a significant trade-off between the level of security and the time taken for authentication processing,

The existing fingerprint recognition systems typically capture a single whole fingerprint image and apply a predetermined algorithm. The type and application sequence of fingerprint recognition algorithms are not chosen in real time by the quality of the fingerprint image captured and the amount of information it can furnish.

There is an unmet market need for a system that captures multiple images of fingerprints, allows single or multiple swipes of the finger(s) in various orientations, and processes the multiple images in parallel so that the identification process requires no additional time when compared to a single swipe fingerprint recognition system.

### SUMMARY OF THE INVENTION

The method and system disclosed herein increases the acceptance rate in fingerprint capturing and authentication by the application of selective, plural and sequenced fingerprint recognition rules using a plurality of sensors. The finger is swiped over multiple sensors. A whole fingerprint sample is constructed from the scan of each of the multiple sensors, thereby generating a multiplicity of whole fingerprint samples. Predetermined selective, plural and sequenced (SPS) fingerprint recognition rules are set for each of the whole fingerprint samples. The sequence of application of the rules is determined real time by the quality of the fingerprint image captured and the amount of information it furnishes. The accuracy level for fingerprint recognition is set by the administrator of the selective, plural and sequenced fingerprint recognition system. The selective, plural and sequenced fingerprint recognition rules are sequentially applied to match the captured fingerprint image with pre-stored fingerprint templates during the registration of the users. The stored fingerprint templates are sequentially filtered until the set accuracy level is achieved.

Another method and system disclosed herein ensures authentication reliability by minimizing the false acceptance rate and false rejection rate. For this purpose, the method of present invention employs more than one sensor to collect multiple fingerprint images of the user.

Another method and system disclosed herein employs more than one sensor to collect multiple fingerprint images of the user, and to also minimize the use of PINs or passwords.

Another method and system is disclosed herein allows collection of multiple images from the user in a single swipe or multiple swipes, and process the collected multiple images to generate multiple fingerprint images using parallel processors in about the same time required to generate a single fingerprint image. Thus, the multiple sensor system is fast and consumes no additional time to generate multiple images.

Another method and system disclosed herein to allow various combinations of the fingers to be captured in sequence or captured simultaneously. For instance, the thumb can be captured first followed by the index finger or the middle finger and the index finger can be captured simultaneously.

Another method and system disclosed herein allows the user the flexibility to conduct multiple swipes at different speeds and in any direction or with any orientation.

Another method and system disclosed herein allows the selection of the most appropriate algorithm “on the fly”, depending on the quality of image captured.

Another method and system disclosed herein is the application of the selected fingerprint recognition rules, to the captured image in a predetermined sequence. The application of appropriate selective, plural and sequenced fingerprint recognition rules makes the filtration process more methodical and reduces the time taken for deriving the authentication decision.

Another method and system is disclosed herein allows the administrator of the authentication system the ability to set an accuracy level for fingerprint recognition.

### BRIEF DESCRIPTION OF THE DRAWINGS

The foregoing summary, as well as the following detailed description of the embodiments, is better understood when read in conjunction with the appended drawings. For the purpose of illustrating the invention, there is shown in the drawings exemplary methods and systems of the invention; however, the invention is not limited to the specific methods and instrumentalities disclosed herein.

FIG. 1 illustrates a method of increasing the acceptance rate in fingerprint scans by the application of selective, plural and sequenced fingerprint recognition method using a plurality of sensors.

FIG. 2 illustrates a fingerprint scan and recognition system for increasing the acceptance rate in a fingerprint scan.

FIG. 3A and FIG. 3B illustrates an algorithm for conducting coarse filtration.

FIG. 4 illustrates the use of a PIN with the fingerprint technique to aid the coarse filtration process.

FIG. 5 illustrates a specific arrangement of multiple sensors.

FIG. 6 illustrates an orthogonal arrangement of multiple sensors.

FIG. 7 illustrates another specific arrangement of multiple sensors.

FIG. 8 illustrates a specific arrangement of a line sensor and an area sensor.

### DETAILED DESCRIPTION OF THE INVENTION

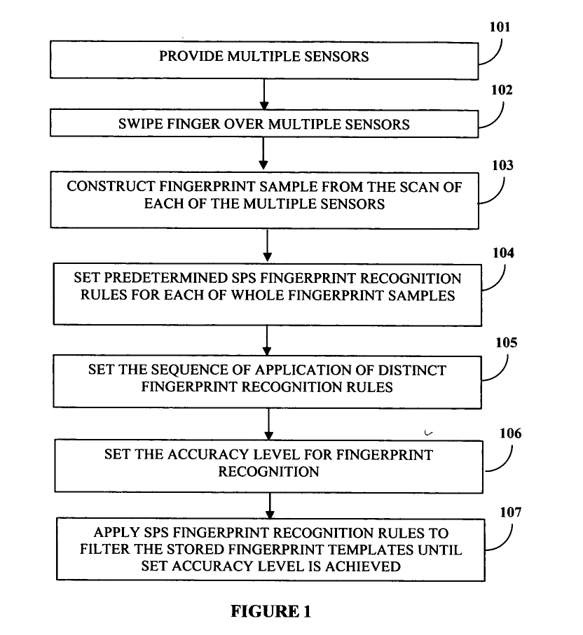

FIG. 1 illustrates a method of increasing the acceptance rate in fingerprint capturing and authentication by the application of selective, plural and sequenced fingerprint recognition rules using a plurality of sensors 101. The finger is swiped 102 over multiple sensors. A whole fingerprint sample is constructed 103 from the scan of each of the multiple sensors, thereby generating a multiplicity of whole fingerprint samples. Predetermined fingerprint recognition rules are chosen 104 depending on the quality of the fingerprint samples captured. The sequence of application of the rules is set 105 for the fingerprint recognition depending on the quality of images captured. The accuracy level for selective, plural and sequenced fingerprint recognition is set 106 by the administrator. The selective, plural and sequenced fingerprint recognition rules are sequentially applied to match the captured fingerprint image with stored fingerprint templates. The stored fingerprint templates are sequentially filtered until the set accuracy level is achieved 107.

The multiple sensors may comprise of a plurality of sensor types. The system may consist of more than one sensor of the same type, or more than one sensor of different types collocated to build up a sensor array wherein each sensor captures a whole image of the finger being swiped over it. For example, a plurality of sensor types may include a capacitive sensor and an optical sensor placed one beneath the other, or adjacent to each other, wherein two separate fingerprint images will be generated by each of the sensors. Also, for example, multiple sensors of same type may include two capacitive sensors placed one beneath the other, wherein separate whole fingerprint images will be generated by each of the sensors.

The method and system disclosed herein supports a plurality of sensor types, inclusive of, but not restricted to capacitive, thermal, optical, tactile, or ultrasonic sensors. The application of these sensors is determined by accuracy, user friendliness and time for processing.

The optical fingerprint sensors enable non-contact fingerprint image detection with a high degree of accuracy. Human fingers consist mainly of three layers, namely-scarfskin, inner skin and tissues under the skin. There are concavo-convex shaped formations, called ridge and valleys on the inner skin. The scarfskin shows these shapes present on the inner skin, these shapes define the fingerprint of the person. As light is transmitted through the tissue a unique pattern of transmittance of light depending on the concavo-convex formation on the inner skin is generated. Each fingerprint has a unique pattern of concavity and convexity and thus each of them generates a pattern that can be distinguished from another. These sensors have low maintenance, high resolution, and are resistant to shock and electrostatic discharge (ESD).

The capacitive fingerprint sensor, as the name implies, works on the principle of capacitance. Capacitance can be defined as the ability to hold electrical charge. The capacitive fingerprint sensor eliminates the limitations of optical scanners. Problems such as edge distortion, misaligned optics, low-image resolution and scratched platens can be easily done away with. Normally parallel plate sensors are employed. A capacitive fingerprint sensor may contain many thousands of capacitive plates, each of which has its own associated electrical circuitry embedded in the form of integrated chips. As soon as a finger is placed on the sensor, an extremely weak electrical charge is built up. This electrical current builds up in a pattern that is determined by the capacitances corresponding to the ridges, valleys and pores that characterize a fingerprint. Every fingerprint has a unique pattern associated with it. The sensor can be made more accurate and reliable using programmable logic internal to the capacitive sensor circuitry and it also makes it possible to adjust the sensor reception to different skin types and environmental conditions.

Thermal fingerprint sensors use micro heaters as the sensing element. The sensing elements are placed in an array. These are micro resistors made of sputtered, very fine platinum film and are placed on a flexible polyamide film substrate. There exists a temperature difference between the skin ridges and the air caught in the fingerprint valleys. The sensor measures and uses this temperature differential to map the fingerprint image. The advantage of using this method is that it is capable of generating a high quality image even on poor quality fingerprints like dry, worn or with little depth between the peaks and valleys of the fingerprint. It can also be used under adverse conditions like extremes of temperature, high humidity, dirt, and oil or water contamination.

Another type of sensor commonly used for fingerprint sensors is the tactile fingerprint sensor. It works on the principle of change in resistivity of a peizoresistive material. As a user passes his finger over the sensor, deflections in the microbeam occur. This deflection corresponds to the ridges and the valleys that characterize the fingerprint. Fingerprint detection is based on the measurement of this deflection. The deflection can be measured by means of piezoresistive gauge. Resistivity change in the piezoresistive gauge is a measure of the deflection. The sensor includes electronic controls that are necessary to scan the row of microbeams and to amplify the signal from the gauges.

Ultrasonic sensors are also used for fingerprint recognition. They employ the basic theory of reflection, diffraction and scattering. When two solid objects are placed against each other, the contact between the surfaces of the two objects is not ideal, i.e., there are some inhomogeneities. As sound waves travel through these surfaces they undergo a phenomenon called contact scattering, along with getting reflected, diffracted and scattered as explained by classical theory of light. This phenomenon effects the sound propagation in the area of contact between the two objects. Using an ultrasonic camera the contact scattered rays are measured to generate the fingerprint image.

The users slides their finger in a direction perpendicular to an array of line sensors, called swipe sensors. Swipe sensors have an area much smaller than the area to be scanned. The direction of sliding of the finger over the sensors is perpendicular to the direction of the sensors. This arrangement allows for the movement of the finger to take place in any direction. For example, if a user slides his finger from top to bottom, or from the bottom to the top over the multiple sensors, the fingerprint image can be collected with equal accuracy.

Whole fingerprint samples are constructed from the scans of each of the multiple sensors so as to generate a multiplicity of whole fingerprint samples. As used herein, the word slide is used interchangeably with the word swipe.

The multiple sensors capture multiple images as the finger is swiped over them. Based on the information captured by each of the sensors, a plurality of whole fingerprint image is reconstructed. Reconstruction is the process of construction of the fingerprint image.

Selective, plural and sequenced fingerprint recognition rules are set for the recognition and matching of each of whole fingerprint samples. Depending on the information furnished by the reconstructed image, the relevant selective, plural and sequenced fingerprint recognition rules that have to be applied to that reconstructed fingerprint image is determined. There is a sequence of application of the selective, plural and sequenced fingerprint recognition rules. For instance, an image may be first matched using the minutiae matching, then matched using the correlation matching.

To find a match between a captured fingerprint image and the fingerprint templates stored in the fingerprint store 202, the captured fingerprint image has to go through numerous stages of filtration. The selective, plural and sequenced fingerprint recognition rules are applied to achieve this filtration in the preferred sequence.

The accuracy level for selective, plural and sequenced and sequenced fingerprint recognition is set by the administrator. The application for which the invention is put into use typically defines the accuracy level. The accuracy level specifies the extent to which a match between a fingerprint image in the fingerprint store 202 and captured image must occur for authentication. The accuracy level to be achieved by the result of filtration process may be expressed as a percentage. For example, the accuracy level can be set at 95% for an office premise and can be set at 99% for a high security governnent office.

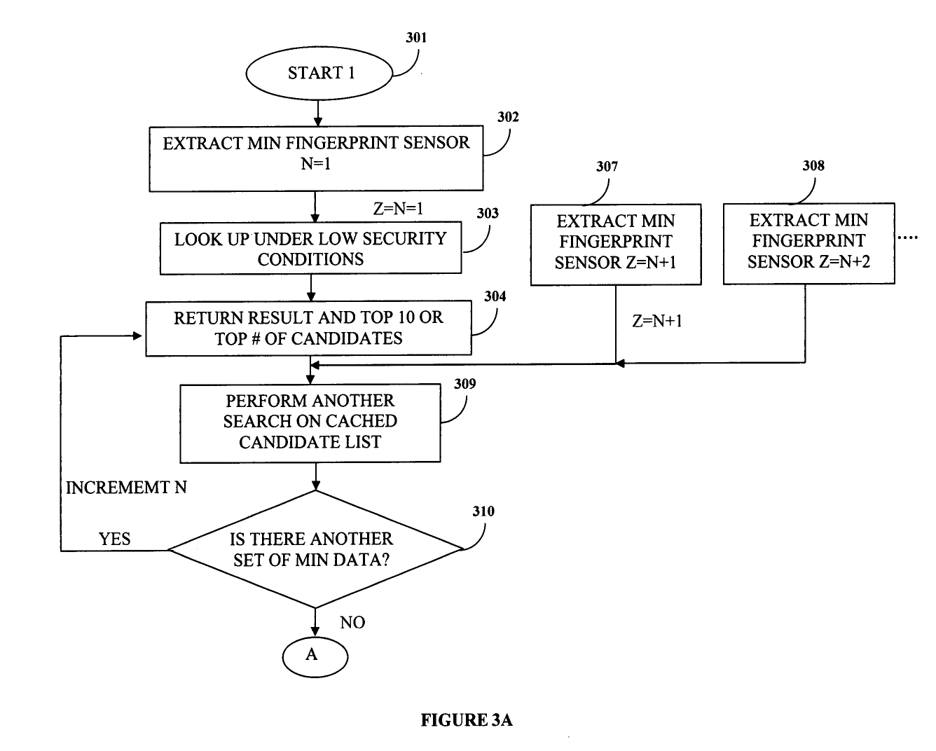

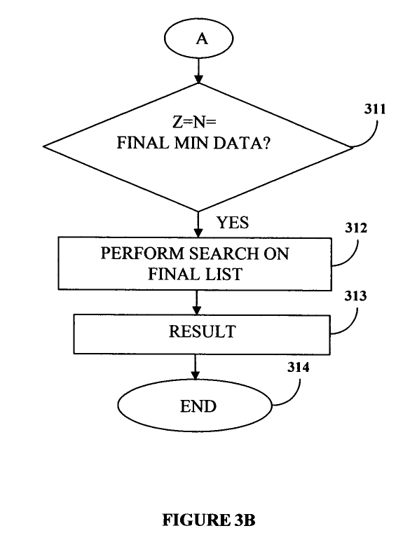

The selective, plural and sequenced fingerprint recognition rules are sequentially applied to the captured fingerprint images for matching them against the stored fingerprint templates. The fingerprint recognition process includes the steps of coarse and fine filtering of the captured fingerprint image. The coarse filtering technique is used to short-list the fingerprint templates and then further fine filtrations are carried out until the preset accuracy level is achieved. The coarse and fine filtering process is later explained in the description of FIG. 3.

The selective, plural and sequenced fingerprint recognition rules comprise a plurality of rules applied to a plurality of captured fingerprint images that are captured from a plurality of types of sensors. For example, the selective, plural and sequenced fingerprint recognition rules comprise a plurality of minutiae rules, correlation fingerprint recognition rules and ridge based fingerprint recognition rules. The rule selection module decides the combination of these rules and the sequence application module decides the sequence in which the rules are applied.

In the case of minutiae fingerprint recognition rules, minutiae point matching is applied. Minutiae points are local ridge characteristics that occur at either a ridge bifurcation or a ridge ending. For the registered user's fingerprint image, all the minutiae points, orientations and structural relationship of the points are detected and stored in the form of templates. During matching, the minutiae points of the templates and the input fingerprint are compared using the fingerprint templates in the fingerprint store 202. Minutiae based matching algorithms are used in the coarse filtering stage. In certain applications, the minutiae matching algorithms do not always provide reliable results. Error is generated due to poor quality images. As the matching is sequential, the error propagates from one stage to another. Therefore, to avoid such errors further image enhancement techniques are employed. The techniques further listed below ensure that the required level of accuracy and reliability is achieved.

The algorithm for minutiae matching, in the first stage, determines the presence of same minutiae, for example, a bifurcation. If the presence of the same minutiae is confirmed, then the algorithm goes on to check if the direction of minutiae flow is also the same as that in the fingerprint image present in the fingerprint store 202. The final step of the minutiae-matching algorithm takes place only after both these conditions are fulfilled. The locations of the minutiae are determined and it is checked if the minutiae occupy the same position relative to each other.

Image distortion occurring due to displacement and elastic deformation can be nullified by an image enhancement techniques and matching algorithm. For example, distortions that occur due to elastic deformation of the image due to excess pressure applied are checked and eliminated by image enhancement techniques. Minutiae matching algorithms address the errors occurring during feature extraction. There are two types of errors in feature extraction stages. One of the errors is missing minutiae, i.e., the inability to detect the minutia points present. Such errors occur due to noise or inadequate ridge structures. Another error is spurious minutia, i.e., the false determination of the presence of minutiae in place of another structure such as ridge, crease, and ridge break. This type of error depends on the performance of the feature extraction process. Therefore, to overcome these shortcomings the method of the present invention employs more than one matching technique.

The selective, plural and sequenced fingerprint recognition rules also comprise a plurality of correlation fingerprint recognition rules. Correlation matching is a technique that overcomes the disadvantages of the minutiae-based approach. But this method too requires precise location of a registration point and is affected by image translation and rotation. But once this is taken care of, the technique provides significantly faster fingerprint matching. Thus, fingerprint correlation has improved performance over minutiae matching technique. In this approach, the similarity between two fingerprints, i.e., fingerprint matching is achieved using more than one method. This technique is very useful in overcoming the shortcomings of an individual technique.

The selective, plural and sequenced fingerprint recognition rules also comprise a plurality of ridge based fingerprint recognition rules. Ridge feature matching is another technique depending on the method of feature extraction. The algorithm depends on extracting texture, shape, frequency orientation and other ridge characteristics for matching.

During registration, fingerprint templates are collected to form a fingerprint store 202 of all the authorized users. For better identification, the user is asked to perform a number of scans at different sliding speeds.

The scanning of the fingerprint can be accomplished in either one of the following techniques. In the first technique, a finger is moved over, or swiped over a static scanner. In the second technique, the finger is held statically over a marked area and the scanner moves and scans the fingerprint. This mechanism is used in static optical fingerprint sensors. A static optical sensor uses the principle of transmission of light to capture the fingerprint image of a finger statically placed on a transparent surface.

Optical fingerprint recognition module includes a processor along with a light sensor system. The processor is responsible for development of the fingerprint image sensed by the sensor. The light sensor system uses light source which are an array of light sensitive diodes. They generate an electrical signal in response to light falling on them. The electrical signal maps the fingerprint image. This mechanism is similar to the one employed in a paper copy machine. In this embodiment of the invention, the sensor may be made to move below the finger, so that each sensor captures a whole fingerprint image.

In another embodiment of the invention, multiple sets of sensors are provided, wherein each set of sensors captures the fingerprint of a different finger. For example, as illustrated in FIG. 5, the different types of sensor are arranged in parallel to each other such that the fingers can be swiped simultaneously. The thumb, the index finger and the middle finger may be swiped simultaneously. The thumb is swiped over the set of capacitive sensors 501, the index finger over the set of optical sensor 502 and the middle finger over the set of the thermal sensors 503. This enables the sensors to collect fingerprint images of more than one finger at a time. Fingerprint matching for more than one fingerprint image may be performed based on these multiple images thereby increasing the overall reliability of the selective, plural and sequenced fingerprint recognition system.

Apart from simultaneous swiping of more than one finger, scanning can be applied sequentially for more than one finger. For example, a user may be asked to swipe the thumb followed by the index finger or the middle finger followed by the index finger. This generates multiple images and enhances the reliability of the SPS fingerprint recognition system. For example, in FIG. 5 the different types of sensors may be arranged in sequence such that the fingers can be swiped one after the other. The thumb, the index finger and the middle finger may be swiped in sequence, the thumb over the set of capacitive sensors 501, the index finger over the optical sensor 502 and the middle finger over the thermal sensors 503.

An example of a plurality of sensor types includes a capacitive sensor and an optical sensor placed one below the other, or adjacent to each other where two separate fingerprint images will be generated by each of the sensors. An example of multiple sensors of same type includes two capacitive sensors placed one below the other where two separate fingerprint images will be generated by each of the sensors. During the registration process the authentic users are asked to swipe more than one finger at different swiping speed to collects the fingerprints of authentic users in different speeds. The plurality of fingerprints is scanned at a plurality of speeds to capture the fingerprint templates of an authorized user. A fingerprint store 202 of fingerprint templates is built up for storing fingerprints of all registered users. These fingerprints act as templates and any new fingerprint captured is compared against these templates stored during the authentication process. A user is authenticated only when there is a match between the fingerprint provided by him or her and their stored fingerprint template.

The fingerprint information captured by the sensors is processed in parallel for fingerprint recognition, thereby reducing the time for authentication. The different fingerprints captured by each of the sensor are individually processed to furnish a complete fingerprint image. This processing is performed in parallel by means of parallel processors to achieve faster processing with a high accuracy level. Parallel processing of multiple images captured by multiple sensors for a higher accuracy of authentication takes about the same time as required by a single sensor to reproduce one complete image for a lower accuracy level of authentication.

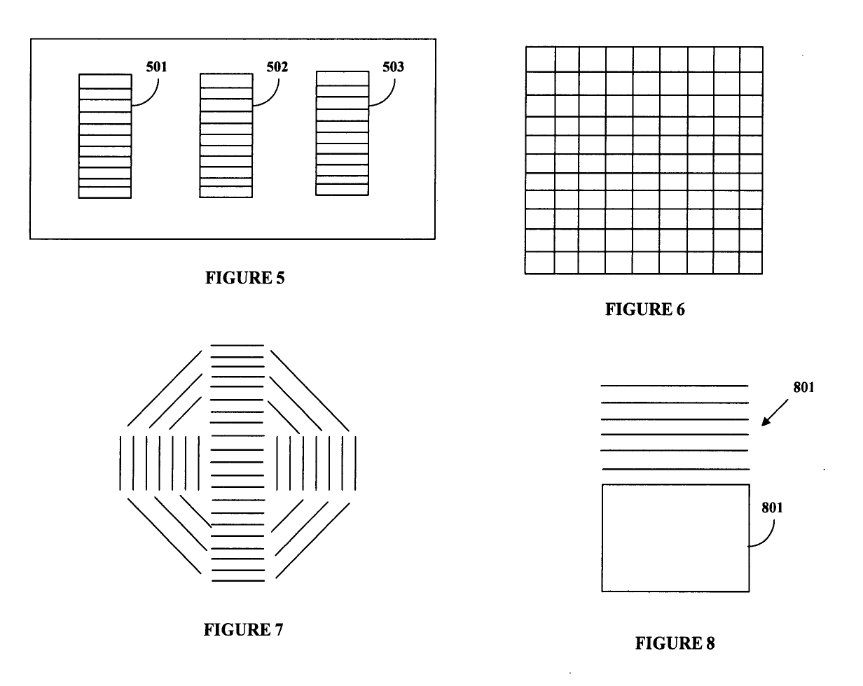

In another embodiment of the invention, the pluralities of sensors are arranged orthogonally to each other, allowing the finger to be swiped in any direction. For example, the arrangement may be such that rows of optical sensors are lined up perpendicular to a row of capacitive sensors. This arrangement is shown in the FIG. 6 and FIG. 7. Such an arrangement allows for the finger to be swiped in any direction. For instance, if a user swipes a finger with a leftward tilt or from bottom to top over the sensor array, the fingerprint image is wholly captured and reproduced. FIG. 8 shows an arrangement where the user first slides down the finger over a set of line sensors 802 and, finally places their finger in a stationery manner over an area sensor. In this case, the area sensor 801 contains a moving optical element that scans the stationary finger.

The selective, plural and sequenced fingerprint recognition system further comprises the option of setting a time limit for the processing for fingerprint recognition. To avoid deadlock situations, a time limit for the processing of fingerprint image is preset. If the system cannot find a match for the fingerprint provided amongst the fingerprint templates stored in the fingerprint store 202 within the stipulated time, it notifies the user that no match has been found, thereby avoiding a situation of deadlock.

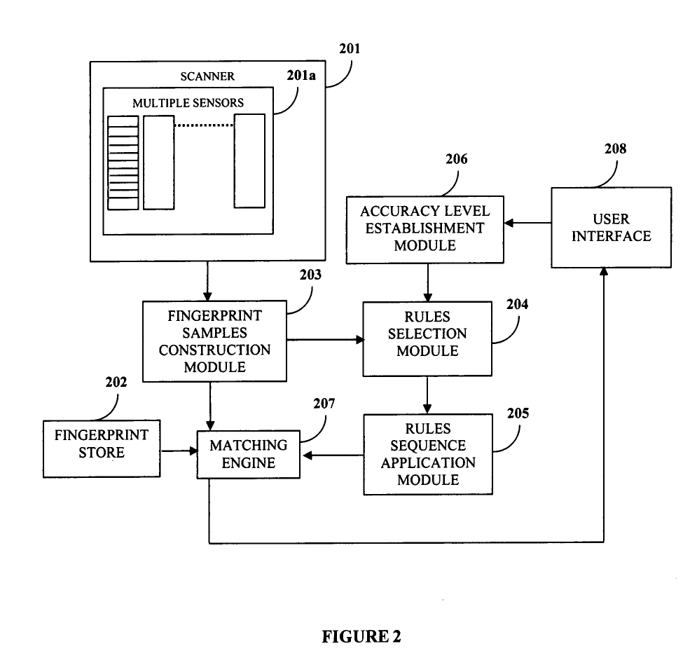

FIG. 2 illustrates a fingerprint scan and recognition system for increasing the acceptance rate in a fingerprint scan. The system comprises a scanner 201 with multiple sensors 201a for capturing fingerprint data. The system consists of a fingerprint store 202 for storing the fingerprint templates of all authorized users during registration process. A fingerprint sample-constructing module 203 comprises parallel processors for constructing a whole fingerprint from each of the multiple sensors. A rule selection module 204 selects the most appropriate selective, plural and sequenced fingerprint recognition rules depending on the whole fingerprint captured. A rule sequence application module 205 determines the sequence of application of the selective, plural and sequenced fingerprint recognition rules. An accuracy level establishment module 206 sets the accuracy level for fingerprint recognition, through a user interface 209. The administrator of the fingerprint scan and recognition system sets the accuracy level through the user interface 208. A matching engine 207 applies the selective, plural and sequenced fingerprint recognition rules to the fingerprint data and also compares the captured fingerprint data with fingerprint templates stored in fingerprint store 202.

The swipe-based sensors use less silicon and thus are cost effective compared to area sensors. A swipe-based sensor can acquire higher resolution images of the finger using only one fifth or less of the silicon as compared to area sensors. In line scanning, the image of the fingerprint is captured by line-by-line scanning of the image.

The information extraction process is carried out during the process of image reconstruction. The complete information from the fingerprint image has to be extracted by using the partial images and simultaneously rejecting over-lapping images as well as distortions. For this purpose, unique information is read from each partial image of the fingerprint. In the information extraction process, when the information extraction from each partial image is completed, the memory is cleared before processing the next image. This clearing process minimizes the processor memory requirement making the system cost effective. Thus, even without having to produce an actual picture of the fingerprint, all the information in the fingerprint image may be gathered. As information extraction and hence verification takes place as the finger moves along the sensor surface, the detection process is rapid.

The fingerprint sample reconstruction module is responsible for the process of reconstruction of the fingerprint. While reconstructing the image from a swipe-based sensor, the two most important things taken into account are variations in swiping speeds and sideways distortions. These factors have to be taken into account in order to produce the correct fingerprint image because the swiping speed as well as orientation of the finger with respect to the sensor surface varies with each swipe. Also, other distortions such as skew, stretching and compression, which are introduced due to unwanted degrees of freedom, are removed prior to identification.

The variation of swiping speed is addressed by measuring the overlap between subsequent partial images of the finger “on the fly”. A fully reconstructed image contains several non-overlapping partial images. To reproduce an image accurately, the number of lines to be scanned depends on factors such as the sensor frequency and signal-processing algorithm used. The signal processing techniques make use of reconstructing algorithms for reconstructing images from a single line swipe sensor. The purpose of the reconstruction algorithm is to eliminate any distortion in the fingerprint images occurring due to varying finger-swiping speed and direction. Reconstruction algorithm addresses orientation and aligns the image appropriately by translation and rotation.

A rule selection module selects the most appropriate selective, plural and sequenced fingerprint recognition rules depending on the whole fingerprints captured. For example, depending on the fact whether the sample is of the tip, middle, or bottom portion of the finger the algorithm changes accordingly. Also the clarity of the sample is considered while deciding the selection of the selective, plural and sequenced fingerprint recognition rule.

The rule sequence application module determines the sequence of application of fingerprint recognition rules. For example, the fingerprint matching samples with clarity minutiae rules applied in the first stage and correlation rules applied in the second stage. If the desired accuracy is reached in the minutiae matching stage, then there is no need of going though the correlation fingerprint recognition rules.

The accuracy level establishment module is used for setting the accuracy level of fingerprint recognition. By application of the recognition rules to the captured image, it is compared to the fingerprint templates present in the fingerprint store 202. The result of the filtrations done by the recognition rules must meet a preset level of accuracy. The accuracy level is set according to the application. For example, the accuracy level set for applications like banks and defense services are much higher to those set for offices and colleges.

The matching engine compares the captured fingerprint data with fingerprint templates stored in fingerprint store 202. The entire processing of the comparing and matching of fingerprint is accomplished using the reconstructed image and a customized sequence of application of the recognition rules.

The fingerprint scanner is a type of a swipe sensor. The fingerprint scanner captures the fingerprint image as the finger is swiped across the sensor. Different mechanisms are employed for obtaining a fingerprint image as the finger is swiped along the fingerprint sensor. The sensor captures the image in the form of more than one slice and then the fingerprint image is generated from these slices. The method of swiping may be any of the following types: swipe fast, swipe slow, swipes with finger tilt left, swipe with fingertip, swipe only half way along the swipe sensor, or swipe a pattern across the sensor.

The method of the present invention captures the fingerprint image in two steps. In the first step, the fingerprint images are obtained in form of slices, and in the second step, the whole fingerprint image is constructed using these slices. The method of this invention calculates the overlap of the slices and correctly places the adjacent slices to generate the fingerprint image. In order for overlaps to occur, the capture rate of the sensor should be sufficiently high. Exact placement of the slices is achieved by correlating the adjacent slice images.

To enhance security, additional features such as asking the user to vary the speed of swiping or asking the user to swipe more than once is implemented via input to a user interface. The system may also ask the user to swipe the finger in a specific manner. A combination of one or more of these methods of collection of swipe data enhances security to a large extent.

During enrollment, the user may be requested to perform a number of secondary swipes in the above-explained method of varying speed and direction of swipes.

A complete matching of the captured fingerprint is carried out with a registered users fingerprint for authentication. Matching can be performed using the wide variety of secondary enrolled swipes, collected under altered swipe conditions. An unknown user may be required to go through a series of secondary swipes and any of them may be chosen at random for comparison with the finger print image of the registered user. The randomness in selecting the secondary swipe is an additional step taken to enhance the security and cramp fraud attempts. A plurality of secondary enrolled swipe images may also be compared to the enrolled images for authentication. In this way, an attempted spoof is made more challenging because any one out of the multiple secondary swipes is chosen for comparison.

FIG. 3A and FIG. 3B illustrates an algorithm for conducting coarse filtering. Start filtering algorithm 301 with extracting the minimum fingerprint information present from the fully constructed fingerprint samples captured by the first sensor (Z=N=1) 302 and initialize the count for the sensors. Perform the matching process considering low security condition 303 and short list the authenticated candidate's fingerprint samples. Extract the minimum fingerprint information from the next sensor (Z=2) 307. Perform another search on the short listed candidates 309. Check if there is any another set of minimum data 310 and increment the count of the sensor to extract the minimum fingerprint information from the next sensor (Z=2) 308. Conduct the process of extraction of minimum data and short-listing from the previous results until all the minimum data required for the identification of the fingerprint exhausts. Check if the count has reached final minimum information 311. Perform the final search on the short listed fingerprints 312 and display the result 313 at the end of the algorithm 314.

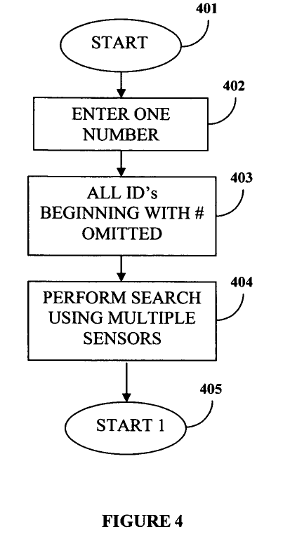

FIG. 4 illustrates the use of personal identification number (PIN) along with the selective, plural and sequenced fingerprint recognition technique to aid the coarse filtering process. Start the process 401 with entering a PIN number 402, so that the matching engine can eliminate all the fingerprints that are not associated with the entered PIN 403. Short-list and cache the fingerprint templates of candidates that match the entered PIN. Carry out the filtering of fingerprint templates for the short listed candidates 404. The coarse filtering algorithm is explained in FIG. 3. The coarse filtering algorithm is continued at step 405. The process of including the PIN with SPS fingerprint recognition makes the authentication process more accurate, efficient and rapid than using only a fingerprint recognition technique.

In one embodiment of the invention an array of sensors are used in conjunction with an array of detectors. In another embodiment of the invention an array of sensors are used in conjunction with a single detector.

This concept of application of selective, plural and sequenced fingerprint recognition rules is not limited to only fingerprint, but can also be extended to the other biometric matching techniques, such as iris, retina, hand or even hand writing matching techniques.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

1. A method of increasing the acceptance rate in a fingerprint scan, comprising the steps of:
providing multiple sensors;
swiping a finger over said multiple sensors;
constructing a whole fingerprint sample from the scan of each of the multiple sensors, thereby generating a multiplicity of whole fingerprint samples;
setting predetermined fingerprint recognition rules for each of said whole fingerprint samples;
setting the sequence of application of said fingerprint recognition rules;
setting the accuracy level for fingerprint recognition; and
sequentially applying the fingerprint recognition rules to the captured fingerprint images for matching said captured fingerprint image with stored fingerprint templates, and sequentially filtering the stored fingerprint templates until said set accuracy level is achieved.

2. The method of claim 1, wherein said fingerprint recognition rules comprise a plurality of minutiae rules.

3. The method of claim 1, wherein said fingerprint recognition rules comprise a plurality of correlation fingerprint recognition rules.

4. The method of claim 1, wherein said fingerprint recognition rules comprise a plurality of ridge based fingerprint recognition rules.

5. The method of claim 1, wherein said fingerprint recognition rules comprise a plurality of minutiae rules, correlation fingerprint recognition rules and ridge based fingerprint recognition rules.

6. The method of claim 1, wherein the multiple sensors comprise of a plurality of sensor types.

7. The method of claim 6, wherein the plurality of sensor types comprises thermal sensors, tactile sensors, optical sensors and capacitive sensors.

8. The method of claim 7, wherein the user swipes their finger in a direction perpendicular to an array of line sensors.

9. The method of claim 1, wherein the plurality of sensors are arranged orthogonally to each other, allowing the finger to be swiped in any direction.

10. The method of claim 1, wherein the finger is static, while the sensor moves and scans the fingerprint.

11. The method of claim 1, wherein multiple sets of sensors is provided, and wherein one or more fingers are swiped simultaneously over said sets of sensors.

12. The method of claim 1, wherein multiple sets of sensors is provided, and wherein one or more fingers are in sequence over said sets of sensors.

13. The method of claim 1, further comprising the steps of capturing fingerprint templates, wherein the fingerprint templates are captured from the authorized users, wherein the users provide a plurality of fingerprint scans at a plurality of speeds during registration.

12. The method of claim 1, wherein fingerprint information captured by the sensors is processed in parallel for fingerprint recognition.

13. The method of claim 1, further comprising the step of setting a time limit for the processing for fingerprint recognition.

14. A system for increasing the acceptance rate in a fingerprint scan, comprising the steps of:
a scanner with multiple sensors for capturing fingerprint data;
a fingerprint store for storing the fingerprint templates of all authorized users during registration;
a fingerprint sample constructing module comprising parallel processors for constructing a whole fingerprint from each of said multiple sensors;
a rule selection module for selecting the most appropriate fingerprint recognition rules depending on the whole fingerprints captured;
a rule sequence application module that determines the sequence of application of said fingerprint recognition rules;
an accuracy level establishment module for setting the accuracy level of fingerprint recognition; and
a matching engine for applying said fingerprint recognition rules to said fingerprint data and comparing the captured fingerprint data with fingerprint templates stored in fingerprint store.
